(19) United States
(12) Patent Application Publication
(10) Pub. No.: US 2013/0304275 A1
(43) Pub. Date: Nov. 14, 2013

(54) ENERGY MANAGEMENT SYSTEM AND METHOD

(71) Applicant: Electronics And Telecommunications Research Institute, (US)

(72) Inventors: Jeong In LEE, Daejeon (KR); Il Woo LEE, Daejeon (KR)

(73) Assignee: ELECTRONICS AND TELECOMMUNICATIONS RESEARCH INSTITUTE, Daejeon (KR)

(21) Appl. No.: 13/891,321

(22) Filed: May 10, 2013

(30) Foreign Application Priority Data
May 11, 2012 (KR) 10-2012-0049982

(51) Int. Cl. G05F 5/00

(52) U.S. Cl. CPC G05F 5/00
USPC 700/297

(57) ABSTRACT

An energy management system may include an electric power system to collect electricity information, an energy service interface to collect at least one piece of energy information of an electricity consumer, at least one virtual power plant (VPP) management group to provide the at least one piece of energy information, and a VPP operating system connected with the electric power system and the energy service interface to collect and manage the electricity information and the at least one piece of energy information.

### CROSS-REFERENCE TO RELATED APPLICATION

This application claims the priority benefit of Korean Patent Application No. 10-2012-0049982, filed on May 11, 2012, in the Korean Intellectual Property Office, the disclosure of which is incorporated herein by reference.

### BACKGROUND

1. Field of the Invention

Exemplary embodiments relate to an energy management system and method for a virtual power plant (VPP), and more particularly, to an energy management system and method for a VPP that may aggregate residential power production, and manage and control distributed generation sources being run like a single power plant.

2. Description of the Related Art

Conventionally, passive attempts have been made to reduce residential energy usage such as, for example, using high energy efficiency appliances or reducing standby power consumption by powering off appliances and devices personally.

With the development of smart products, recent energy saving trends are moving towards operating smart appliances in an energy saving mode at peak times and in a normal mode at off-peak times based on real time price information being received through the smart appliances.

However, energy saving technologies are still passive in view of reducing consumption of energy supplied by an electric power system.

Future energy saving technologies need to advance to a more active approach, including, for example, self-sufficiency in residential energy supply and demand with the support of renewable energy generation and an energy storage system connected to a home, aggregation and management of surplus energy in the home by a virtual power plant (VPP), and profit creation through energy trading.

A smart grid corresponds to a form of an electric grid network using digital technology to support an energy production and distribution system for optimum energy efficiency. Recently, a smart grid has been gaining traction globally, and many governments are adopting and enacting smart grid policies.

Based on infrastructure, a demand response enables consumers to participate in energy savings actively in response to real-time changes to prices based on electricity demand.

As domestic renewable energy generation and real-time energy trading becomes more available, energy saving technologies boost an energy storage device to resolve the imbalance in the supply and demand relationship for energy.

Domestic energy management systems for monitoring and controlling energy usage in the home are under development, however, energy saving technologies primarily focus on supply-side energy management.

Traditional energy saving technologies are unable to provide VPP-assisted supply and trading functions of energy collected from households.

Existing VPPs operate in cooperation with small-scale cogeneration plants producing 3 kilowatts (kW) and 50 megawatts (MW), distributed energy generations including renewable energy generations, microgrids, energy storage devices, demand response resources, and the like, and domestic renewable energy generations of 3 kW or less are excluded from consideration for the implementation of VPPs.

Load management programs, mainly serving large customers, allow the supply of electricity agreed between consumers and load management companies to be controlled remotely and maintain electricity prices.

### SUMMARY

According to an aspect of the present invention, there is provided an energy management system including an electric power system to collect electricity information, an energy service interface to collect at least one piece of energy information of an electricity consumer, at least one virtual power plant (VPP) management group to provide the at least one piece of energy information, and a VPP operating system connected with the electric power system and the energy service interface to collect and manage the electricity information and the at least one piece of energy information.

The electric power system may include a market operating system and a system operating system, and the electricity information may include real-time price acquisition information received from the market operating system, and electricity demand information and electricity reserve information received from the system operating system.

The energy service interface may include at least one of a smart meter, a home server, a home gateway, a wallpad, and a mobile terminal.

The VPP management group may include a renewable energy collecting device to collect at least one renewable energy resource, an energy storage system to store the at least one renewable energy resource collected, and an energy management system to meter and manage energy supply and demand state information associated with the at least one renewable energy resource.

According to another aspect of the present invention, there is provided an energy management system including a first collecting unit to collect renewable energy generation information and energy supply and demand state information from at least one VPP management group, a second collecting unit to collect demand response participation information from the VPP management group, a determining unit to determine a type of demand response participation for the VPP management group, a third collecting unit to collect renewable energy supply information and energy saving information based on a result of the type determination, an information collecting unit to collect the renewable energy supply information, the energy saving information, and the energy supply and demand state information, a calculating unit to calculate incentive information for the VPP management group based on a result of the collection, and a transmitting unit to transmit the incentive information to the VPP management group.

The calculating unit may calculate an energy supply contribution per household for the VPP management group based on the renewable energy supply information.

The calculating unit may calculate an energy saving contribution per household for the VPP management group based on the energy saving information.

The calculating unit may set the incentive based on the energy saving contribution per household or the energy supply contribution per household.

According to still another aspect of the present invention, there is provided an energy management method including collecting renewable energy generation information and energy supply and demand state information from at least one VPP management group, collecting demand response participation information from the VPP management group, determining a type of demand response participation for the VPP management group, collecting renewable energy supply information and energy saving information based on a result of the type determination, collecting the renewable energy supply information, the energy saving information, and the energy supply and demand state information, calculating incentive information for the VPP management group based on a result of the collection, and transmitting the incentive information to the VPP management group.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an energy management system according to an exemplary embodiment;

FIG. 2 is an operational flow diagram illustrating an energy management method according to an exemplary embodiment;

FIG. 3 is an operational flow diagram illustrating an energy management method according to another exemplary embodiment; and

FIG. 4 is a flowchart illustrating an energy management method in a virtual power plant (VPP) operating system according to an exemplary embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein.

The examples used herein are intended merely to facilitate an understanding of manners in which the embodiments herein can be practiced and to further enable those of skill in the art to practice the embodiments herein. Accordingly, the examples should not be construed as limiting the scope of the embodiments herein. Like reference numerals refer to the like elements throughout.

An energy management system according to an exemplary embodiment may be based on a network of energy management components for managing residential energy usage similar to a virtual power plant (VPP), and may provide a function for a VPP operating procedure.

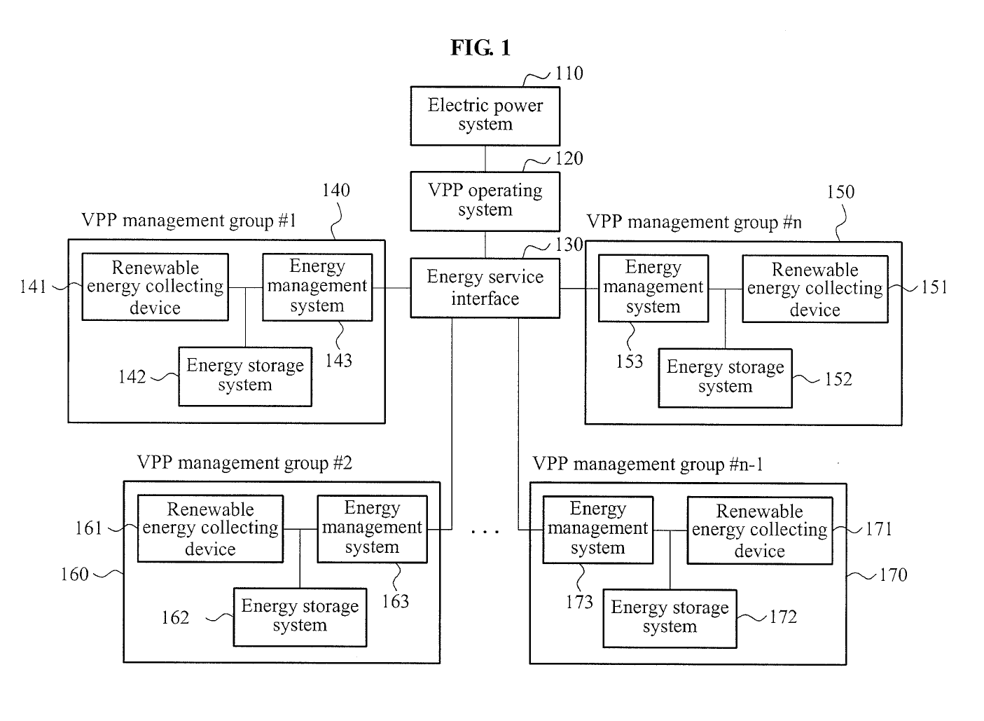

FIG. 1 is a block diagram illustrating an energy management system according to an exemplary embodiment.

Referring to FIG. 1, the energy management system according to an exemplary embodiment may include an electric power system 110 to collect electricity information, an energy service interface 130 to collect at least one piece of energy information of electricity consumers, at least one VPP management group 140, 150, 160, and 170 to provide the at least one piece of energy information, and a VPP operating system 120 connected with the electric power system 110 and the energy service interface 130 to collect and manage the electricity information and the at least one piece of energy information.

According to an exemplary embodiment, the electric power system 110 may include a market operating system and a system operating system.

Here, the electricity information may include real-time price acquisition information received from the market operating system, and electricity demand information and electricity reserve information received from the system operating system.

According to an exemplary embodiment, the energy service interface 130 may include various relays for transferring information associated with energy, for example, a smart meter, a home server, a home gateway, a wallpad, a mobile terminal, and the like.

According to an exemplary embodiment, the VPP management groups 140, 150, 160, and 170 may include renewable energy collecting devices 141, 151, 161, and 171, respectively, to collect at least one renewable energy resource, energy storage systems 142, 152, 162, and 172 to store the at least one renewable energy resource collected, and energy management systems 143, 153, 163, and 173 to measure and manage energy supply and demand state information associated with the at least one renewable energy resource.

According to an exemplary embodiment, a load management company may provide energy trading and control functions using the energy management systems 143, 153, 163, and 173 through the VPP operating system.

Hereinafter, a VPP operating method for energy saving-based demand response participation is described in detail.

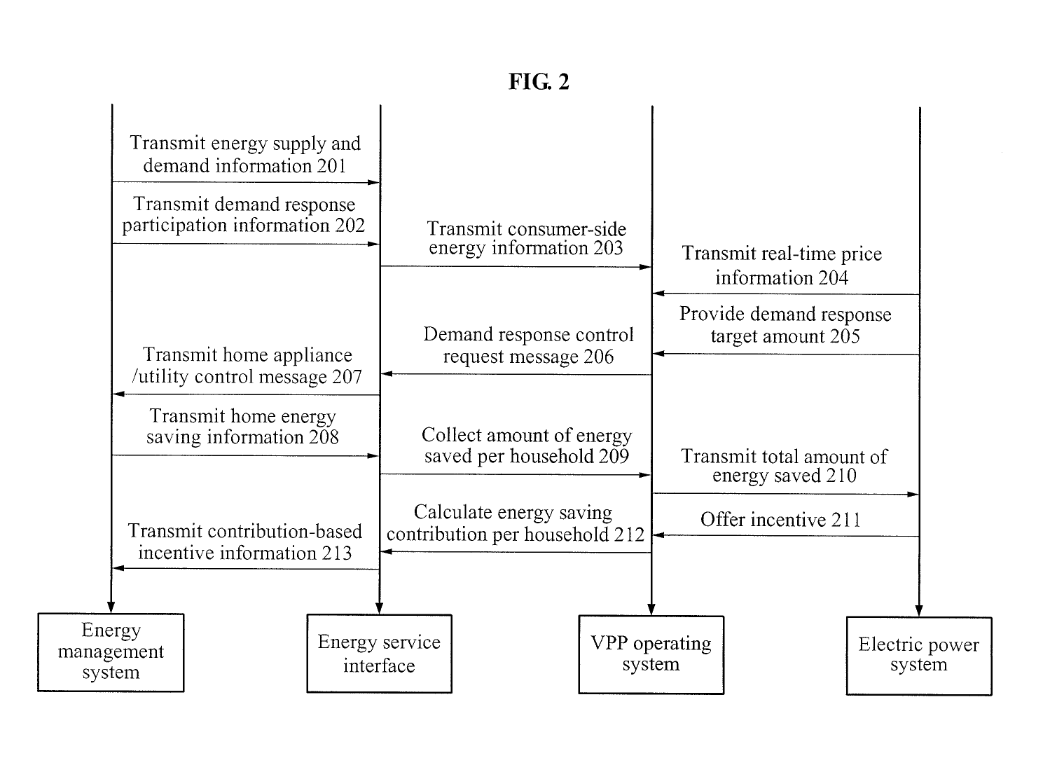

FIG. 2 is an operational flow diagram illustrating an energy management method according to an exemplary embodiment.

Referring to FIG. 2, in operation 201, an energy management system according to an exemplary embodiment may collect home energy supply and demand information, and in operation 202, may transmit demand response participation information through a reduction in appliance/utility usage in the home to an energy service interface.

In operation 203, the energy service interface may collect consumer-side energy information and may transmit the collected information to a VPP operating system.

In operations 204 and 205, the VPP operating system may receive real-time price information and demand response target amount information from an electric power system.

Here, the demand response target amount information may correspond to information necessary for energy demand management and for operation and reliability improvement of a renewable energy system.

In operation 206, the VPP operating system may transmit a demand response control request message to consumers participating in demand response based on the collected information.

In operation 207, an energy management system may formulate an energy saving-based demand response by controlling appliances/utilities in the home in an energy saving mode based on a home appliance/utility control message being received.

In operation 208, the energy management system may transmit home energy saving information to the energy service interface.

In operation 209, the VPP operating system may collect an amount of energy saved per household.

In operation 210, the VPP operating system may transmit a total amount of energy saved of households participating in the demand response to the electric power system.

In operation 211, the electric power system may offer an incentive for the total amount of energy saved based on the collected information.

In operation 212, the VPP energy management system may calculate an energy saving contribution per household for the demand response participants, and in operation 213, may transmit contribution-based incentive information to each of the participants.

Hereinafter, a VPP operating method for energy supply-based demand response participation is described in detail.

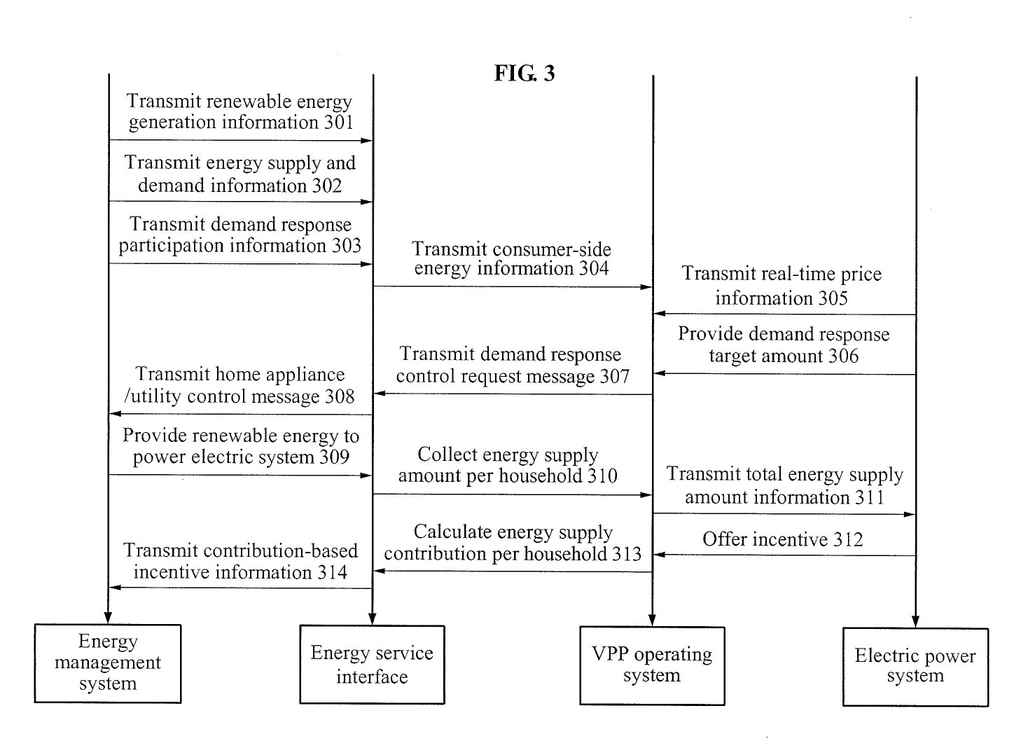

FIG. 3 is an operational flow diagram illustrating an energy management method according to another exemplary embodiment.

Referring to FIG. 3, in operations 301 and 302, an energy management system may collect renewable energy generation information and home energy supply and demand information, for example, a capacity of a renewable energy installation, an amount of renewable energy generated, and a total capacity of an energy storage system, and may transmit the collected information to an energy service interface.

In operation 303, the energy management system may transmit demand response participation information to the energy service interface.

Here, the demand response participation information may represent energy generated from a home renewable energy source being provided to an electric power system.

In operation 304, the energy service interface may collect consumer-side energy information, and may transmit the collected information to a VPP operating system.

In operations 305 and 306, the VPP operating system may receive real-time price information and demand response target amount information from an electric power system.

Here, the demand response target amount information may represent information necessary for energy demand management and for operation and reliability improvement of a renewable energy system.

In operation 307, the VPP operating system may transmit a demand response control request message to consumers participating in demand response.

In operation 308, the energy management system may formulate a demand response by transmitting energy from a home renewable energy source to the electric power system based on a home appliance/utility control message being received.

In operation 309, the energy management system may transmit home renewable energy supply information to the energy service interface.

In operation 310, the VPP operating system may collect an energy supply amount per household.

In operation 311, the VPP operating system may transmit total energy supply amount information of households participating in the demand response to the electric power system.

In operation 312, the electric power system may offer an incentive for the total energy supply amount to the VPP operating system based on the received information.

In operation 313, the VPP operating system may calculate an energy supply contribution per household for the demand response participants, and in operation 314, may transmit contribution-based incentive information to each of the participants.

Hereinafter, an energy management method in the VPP operating system according to an exemplary embodiment is described in further detail.

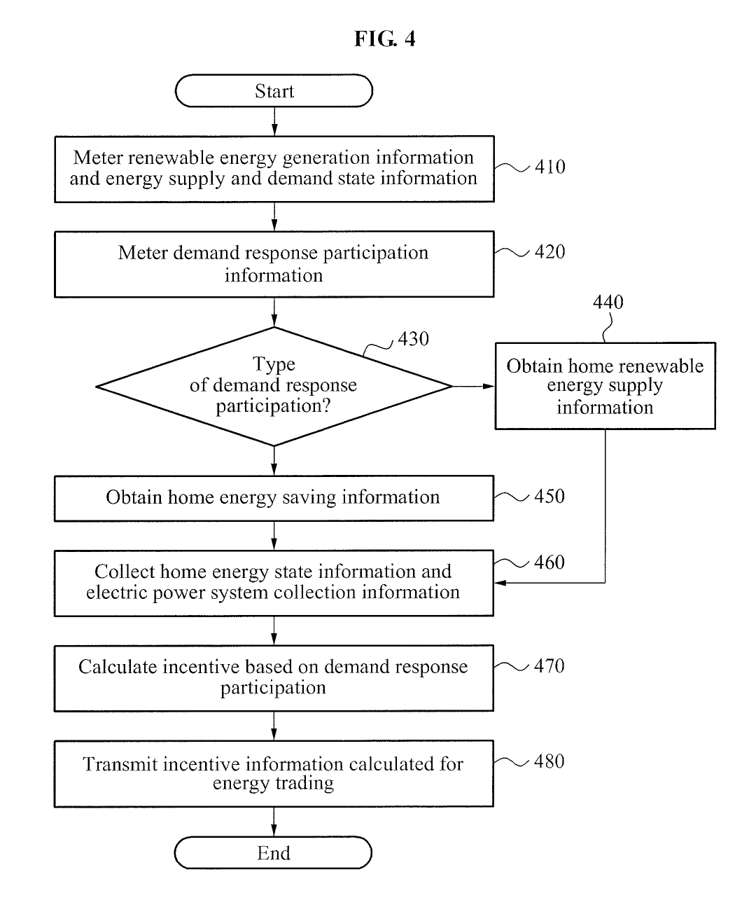

FIG. 4 is a flowchart illustrating an energy management method in a VPP operating system a according to an exemplary embodiment.

Referring to FIG. 4, in operation 410, the VPP operating system may meter, using a first collecting unit, renewable energy generation information and energy supply and demand state information from at least one VPP management group.

In operation 420, the VPP operating system may meter, using a second collecting unit, demand response participation information from each VPP management group.

In operation 430, the VPP operating system may determine, using a determining unit, a type of demand response participation for each VPP management group.

In operations 440 and 450, the VPP operating system may obtain, using a third collecting unit, renewable energy supply information and energy saving information based on a result of the type determination.

In operation 460, the VPP operating system may collect, using an information collecting unit, the renewable energy supply information, the energy saving information, and the energy supply and demand state information.

In operation 470, the VPP operating system may calculate, using a calculating unit, incentive information for each VPP management group based on a result of the collection.

The calculating unit may calculate energy supply contribution per household for each VPP management group based on the renewable energy supply information.

The calculating unit may calculate energy saving contribution per household for each VPP management group based on the energy saving information.

The calculating unit may set the incentive based on the energy saving contribution per household or the energy supply contribution per household.

In operation 480, the VPP operating system may transmit, using a transmitting unit, the incentive information to each VPP management group.

According to an exemplary embodiment, each VPP management group may include a renewable energy collecting device to collect at least one renewable energy resource, an energy storage system to store the at least one renewable energy resource, and an energy management system to meter and manage energy supply and demand state information associated with the at least one renewable energy resource.

According to an exemplary embodiment, a VPP operating system may be connected with an energy storage system, a renewable energy source, an energy management system, and an electric power system in the home, and may provide and manage incentive information associated with energy trading based on a type of demand response participation.

The exemplary embodiments may provide a VPP operating system based on demand response involving active energy saving activities of consumers.

The exemplary embodiments may collect energy information associated with demand response based on supply of renewable energy to an electric power system.

The exemplary embodiments may provide functions for demand response control request and energy trading incentive calculation.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An energy management system comprising:
an electric power system to collect electricity information;
an energy service interface to collect at least one piece of energy information of an electricity consumer;
at least one virtual power plant (VPP) management group to provide the at least one piece of energy information; and
a VPP operating system connected with the electric power system and the energy service interface to collect and manage the electricity information and the at least one piece of energy information.

2. The energy management system of claim 1, wherein the electric power system comprises a market operating system and a system operating system, and
the electricity information includes real-time price acquisition information received from the market operating system, and electricity demand information and electricity reserve information received from the system operating system.

3. The energy management system of claim 1, wherein the energy service interface includes at least one of a smart meter, a home server, a home gateway, a wallpad, and a mobile terminal.

4. The energy management system of claim 1, wherein the VPP management group comprises:
a renewable energy collecting device to collect at least one renewable energy resource;
an energy storage system to store the at least one renewable energy resource collected; and
an energy management system to meter and manage energy supply and demand state information associated with the at least one renewable energy resource.

5. An energy management system comprising:
a first collecting unit to collect renewable energy generation information and energy supply and demand state information from at least one virtual power plant (VPP) management group;
a second collecting unit to collect demand response participation information from the VPP management group;
a determining unit to determine a type of demand response participation for the VPP management group;
a third collecting unit to collect renewable energy supply information and energy saving information based on a result of the type determination;
an information collecting unit to collect the renewable energy supply information, the energy saving information, and the energy supply and demand state information;
a calculating unit to calculate incentive information for the VPP management group based on a result of the collection; and
a transmitting unit to transmit the incentive information to the VPP management group.

6. The energy management system of claim 5, wherein the VPP management group comprises:
a renewable energy collecting device to collect at least one renewable energy resource;
an energy storage system to store the at least one renewable energy resource collected; and
an energy management system to meter and manage energy supply and demand state information associated with the at least one renewable energy resource.

7. The energy management system of claim 5, wherein the calculating unit calculates an energy supply contribution per household for the VPP management group based on the renewable energy supply information.

8. The energy management system of claim 5, wherein the calculating unit calculates an energy saving contribution per household for the VPP management group based on the energy saving information.

9. The energy management system of claim 7 or 8, wherein the calculating unit sets the incentive based on the energy saving contribution per household or the energy supply contribution per household.

10. An energy management method comprising:
collecting renewable energy generation information and energy supply and demand state information from at least one virtual power plant (VPP) management group;
collecting demand response participation information from the VPP management group;
determining a type of demand response participation for the VPP management group;
collecting renewable energy supply information and energy saving information based on a result of the type determination;
collecting the renewable energy supply information, the energy saving information, and the energy supply and demand state information;
calculating incentive information for the VPP management group based on a result of the collection; and
transmitting the incentive information to the VPP management group.

11. The energy management method of claim 10, wherein the VPP management group comprises:
a renewable energy collecting device to collect at least one renewable energy resource;
an energy storage system to store the at least one renewable energy resource collected; and
an energy management system to meter and manage energy supply and demand state information associated with the at least one renewable energy resource.

12. The energy management method of claim 10, wherein the calculating of the incentive information comprises calculating an energy supply contribution per household for the VPP management group based on the renewable energy supply information.

13. The energy management method of claim 10, wherein the calculating of the incentive information comprises calculating an energy saving contribution per household for the VPP management group based on the energy saving information.

14. The energy management method of claim 12 or 13, wherein the calculating of the incentive information further comprises setting the incentive based on the energy saving contribution per household or the energy supply contribution per household.
